(19) United States
(12) Patent Application Publication
(10) Pub. No.: US 2013/0040735 A1
(43) Pub. Date: Feb. 14, 2013

(54) GAME APPARATUS

(71) Applicants: Shinya Suga, Tokyo (JP); Etsushi Takashi, Tokyo (JP); Shingo Ishii, Tokyo (JP)

(72) Inventors: Shinya Suga, Tokyo (JP); Etsushi Takashi, Tokyo (JP); Shingo Ishii, Tokyo (JP)

(73) Assignee: KONAMI DIGITAL ENTERTAINMENT CO., LTD., Tokyo (JP)

(21) Appl. No.: 13/643,144

(22) PCT Filed: May 31, 2011
(86) PCT No.: PCT/JP2011/062461

§ 371 Date: Oct. 24, 2012

(30) Foreign Application Priority Data
Jun. 3, 2010 (JP) 2010-128091

(51) Int. Cl. A63F 13/12

(52) U.S. Cl. 463/34

(57) ABSTRACT

A game apparatus includes multiple stations at each of which at least one player plays a game; multiple screens, at least one of the screens being associated with each of the multiple screens; and a single image projecting device adapted for projecting an image to be displayed on each of the screens. An image to be displayed on each screen is projected from a single image projecting device to each screen, so that it is unnecessary to provide multiple display devices for stations, respectively. Accordingly, the production cost of the game apparatus is low.

### FIELD OF THE INVENTION

The present invention relates to game apparatuses.

### BACKGROUND ART

There is a known type of multiplayer game apparatus, such as a coin pusher game apparatus. For example, the coin pusher game apparatus disclosed in Patent Document 1 includes multiple stations at each of which one or more players can play the game, and each of which includes a station monitor (display device) for outputting images corresponding to progress of the game executed at the station.

Patent Document 1: JP-B-4418798

### SUMMARY OF THE INVENTION

However, the technique disclosed in Patent Document 1 has a drawback in that the production cost of the game apparatus is high since the display devices should be provided at each of the stations.

The present invention provides a multiplayer game apparatus having low production cost.

A game apparatus according to the present invention includes multiple stations at each of which at least one player plays a game; one or multiple screens associated with the multiple stations; and a single image projecting device adapted for projecting an image to be displayed on each of the screens.

In the present invention, at least one screen is provided for, and is associated with, each station, and an image to be displayed on each screen is projected from a single image projecting device to each screen, so that it is unnecessary to provide multiple display devices for each of the stations. Accordingly, the production cost of the game apparatus is low.

In an aspect of the game apparatus according to the present invention, it is preferable that each of the screens be inclined with respect to a horizontal plane. Viewability of images on the screen is improved when the line of sight of the player's eyes is nearly vertical to the screen. Accordingly, in this aspect, the viewability of images on the screen is improved. The inclination angles of the screens with respect to the horizontal plane may be the same or different. However, if the inclination angles of the screens are the same, the viewability of the images on the screen is the same as that on another screen, so that an equal effect can be provided to players at different stations.

In an aspect of the game apparatus according to the present invention, the screens may be formed as a single ring-shaped unit. Part or all of the screens may be arranged with spaces therebetween.

In an aspect of the game apparatus according to the present invention, each of the stations may include a field in which a game is played (for example, a pusher field). If each of the screens is inclined with respect to a horizontal plane, the viewability of the game images on the screens is good even if a player is far from the screen to some degree. Consequently, each field for game play can be located between the screen and the player. This makes effective use of the space.

In an aspect of the game apparatus according to the present invention, the image projecting device is adapted for projecting a set of images bridging neighboring screens. An example of the “set of images” is a laterally wide panoramic image bridging neighboring multiple screens. It is unnecessary to connect neighboring multiple screens, and spaces can be provided between screens. However, if neighboring screens are adjoining, the set of images will not have any interruptions, emphasizing the unity. If the screens are formed as a single ring-shaped unit, a panoramic image bridging multiple screens and continuously running around can be represented naturally.

An aspect of the game apparatus according to the present invention includes at least one subscreen, in which the image projecting device is adapted for projecting an image to be displayed on each of the screens and an image to be displayed on the subscreen simultaneously. In this aspect, since an image different from that displayed on each screen can be displayed on each subscreen, additional excitement can be represented independently of the images on the screens.

In this aspect, the screens and the at least one subscreen are located in a projected region projected by the image projecting device, and the image projecting device may cause an image projected to the projected region other than the screens and the at least one subscreen to be black. Accordingly, part of the projected region (image regions) and the other part (background region) can be clearly distinguished. As a result, images on the screens and the subscreens can be emphasized.

The game apparatus may further include an image generation device adapted for generating projection image data indicating images to be displayed on the projected region by mixing image data indicating images to be displayed on the screens and image data indicating images to be displayed on the at least one subscreen, and is adapted to supply the projection image data to the image projecting device. In this aspect, projection image data in which image data indicating images to be displayed on the screens and image data indicating images to be displayed on the at least one subscreen are mixed is supplied to the single image projecting device. Images to be displayed on the screens and the at least one subscreen are projected by the single image projecting device to the screens and the at least one subscreen, so that it is not necessary to prepare a large number of image projecting devices of which the number is the total number of the screens and the subscreen (total number of images).

In an aspect of the game apparatus according to the present invention, the game apparatus may further include a reflector located above or below the screens and the at least one subscreen, the reflector reflecting image light irradiated from the image projecting device to project the images to the screens and the at least one subscreen. In this aspect, since the reflector reflects image light irradiated from the image projecting device to project the images to the screens and the at least one subscreen, the locations of the image projecting device and the screens and at least one subscreen can be set so that the size of the unit in which the image projection device is contained can be suitable. The embodiment of the reflector is optional, and for example, it may be a plane mirror or a convex mirror. If a convex mirror is used for the reflector, the irradiation distance of image can be shortened for a predetermined irradiated area. The larger the curvature of the convex mirror, the higher the effect (shortening the irradiation distance of image).

### BRIEF DESCRIPTION OF THE DRAWINGS

FIG. 1 is a perspective view of a game apparatus according to a first embodiment of the present invention;

FIG. 2 is a perspective view showing a part inside the game apparatus according to the embodiment;

FIG. 3 is a front view showing the part inside the game apparatus according to the embodiment;

FIG. 4 is a plan view taken along line A-A in FIG. 3;

FIG. 5 is a block diagram showing schematic of a controlling system in the game apparatus;

FIG. 6 is a schematic view for explaining a coin pusher game played at a station;

FIG. 7 is a plan view showing multiple first screens connected seamlessly as a single unit without second screens;

FIG. 8 is a schematic view showing a set of panoramic images projected to a display element;

FIG. 9 is a plan view showing a variation in which multiple subscreens are arranged in a projected region;

FIG. 10 is a plan view of a display element of a variation according to the present invention viewed from above;

FIG. 11 is a plan view showing a display element of a variation including a section in which the first screens are arranged without a space and another section in which the first screens are arranged with spaces therebetween;

FIG. 12 is a schematic view showing a concave display element;

FIG. 13 is a schematic view showing a semispherical display element; and

FIG. 14 is a schematic view showing display elements provided for stations, independently.

### DESCRIPTION OF EMBODIMENTS

### A: First Embodiment

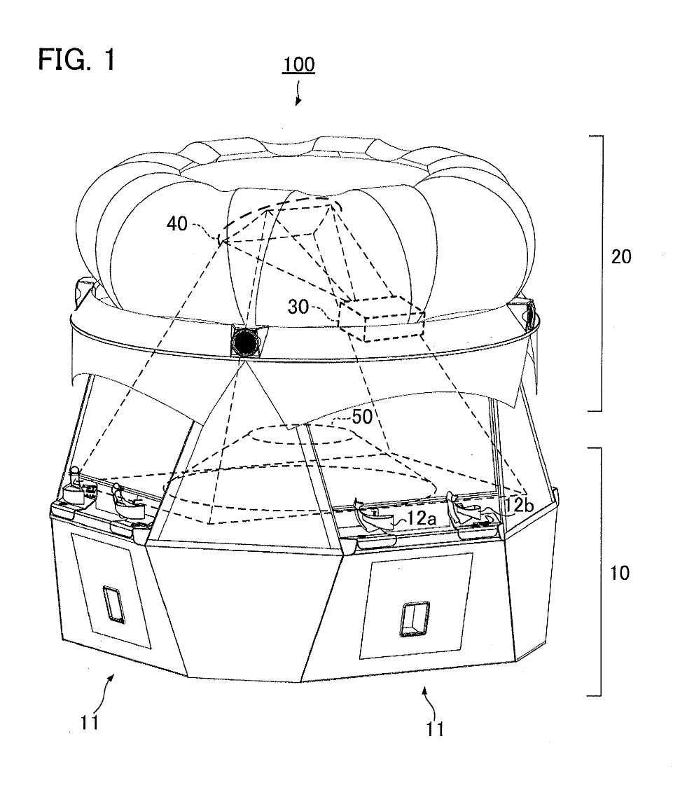

FIG. 1 is a perspective view of a game apparatus 100 according to a first embodiment of the present invention. In the game apparatus 100, a coin pusher game is played. As shown in FIG. 1, the game apparatus 100 according to the embodiment includes a base unit 10 and a ceiling unit 20. The base unit 10 includes multiple stations 11, at each of which two players can play the game. As shown in FIG. 1, each station 11 includes a medal slot 12a in which a first player drops medals (coins) and another medal slot 12b in which a second player drops medals. A display element 50 of a shape of a circular truncated cone or a multi-sided truncated pyramid protrudes from a central part of the upper surface of the base unit 10. Multiple pusher fields (not shown) are located on the upper surface of the game apparatus 100, the number of pusher fields being the same as the number of the stations 11. In FIG. 1, detailed illustration is omitted.

As shown in FIG. 1, there are a projector 30 and a reflector 40 inside the ceiling unit 20. In this embodiment, a convex mirror is used as the reflector 40. The projector 30 is an image projecting device for projecting images. Image light projected from the projector 30 is reflected by the reflector 40. The image light reflected by the reflector 40 is enlarged and is projected to the display element 50 in the shape of a circular truncated cone or a multi-sided truncated pyramid protruding from the central part of the upper surface of the base unit 10. Because this embodiment includes the reflector 40 that reflects the image light projected from the projector 30 and projects it to the display element 50 in an enlarged manner, the distance between the projector 30 and the display element 50 can be shorted in comparison with another scheme in which the image light projected from the projector 30 is directly irradiated to the display element 50 without the reflection by the reflector 40. As a result, the size of the ceiling unit 20 in which the projector 30 and the reflector 40 are contained can be restricted suitably.

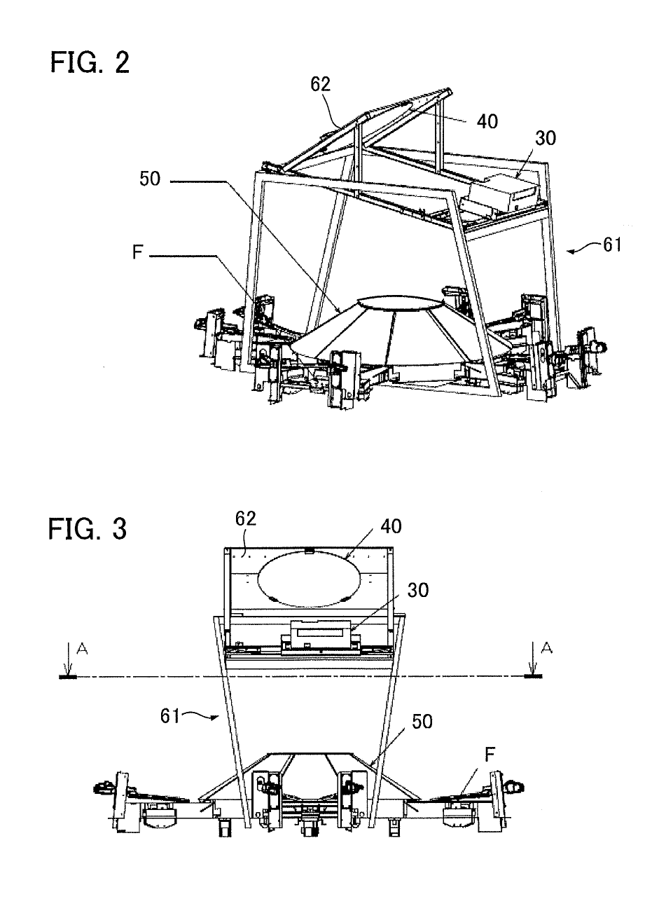

FIG. 2 is a perspective view showing a part inside the game apparatus 100, whereas FIG. 3 is a front view showing the part. As shown in FIGS. 2 and 3, the projector 30 is mounted on a trestle 61 and is located above the display element 50. The reflector 40 is attached to an attachment plate 62 provided at the trestle 61 and is located above the display element 50 in such a manner that the incident angle of the image light from the projector 30 is a predetermined value. In this embodiment, the locations of the projector 30 and the reflector 40 are set so that the image projected to the display element 50 has minimum distortion. In this embodiment, the reflector 40 is located above the display element 50, but it may be located below the display element 50 (rear projection scheme).

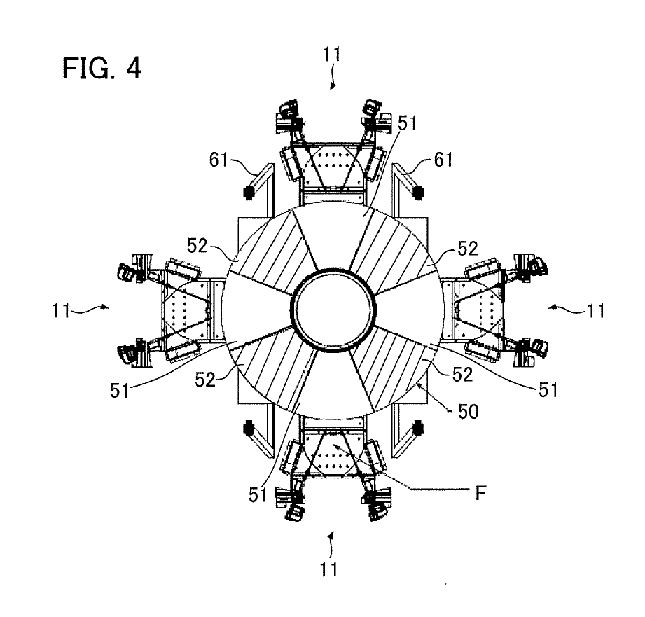

FIG. 4 is a plan view taken along line A-A in FIG. 3. As shown in FIG. 4, the display element 50 of a shape of a circular truncated cone or a multi-sided truncated pyramid has a side face that is formed by multiple screens (surfaces to which image is projected) connected seamlessly. Details follow.

The multiple screens include multiple first screens 51 and multiple second screens 52. The first screen 51 and the second screen 52 are alternately arranged and are connected seamlessly, so as to form the side face of the display element 50 in a shape of a circular truncated cone or a multi-sided truncated pyramid. The first screens 51 are provided for the multiple stations 11, respectively. In this embodiment, four first screens 51 are provided for four stations 11, respectively. However, the number of stations 11 and the number of the first screens 51 may be freely selected. A first screen 51 corresponding to a station 11 is located in such a manner that the players playing at the station 11 can view the first screen 51. As will be described later, on each of the first screen 51, an image corresponding to progress of the game executed at the station 11 corresponding to the first screen 51 is displayed.

In this embodiment, each second screen 52 is a surface to which an image that is different from images projected to the first screens 51 is projected in order to specify borders of the first screens 51. As will be described later, a decorative image that is not related to the game is displayed on each of the second screens 52. The “decorative image” is an image specifying borders of the first screens 51 as mentioned above, and the type of the decorative image may be freely selected. For example, it may be a unicolor (e.g., black) image on each of the second screens 52, or it may be an image with a pattern on each of the second screens 52.

The “screen” is meant to be a surface to which an image is projected. In this embodiment, the side face of the display element 50 is a continuous face, and a section (a partial surface) of the side face of the display element 50 to which a game image corresponding to progress of the game played at a station 11 is projected is understood as the first screen 51 corresponding to the station 11. In addition, another section (a partial surface) of the side face of the display element 50 to which a decorative image is projected is understood to be a second screen 52. In this embodiment, the side face of the display element 50 is a continuous face, but it may be formed by multiple display plates (plates to which images are projected) connected continuously. In such a variation, each display plate may be located at a position facing to the players playing at a station 11 in order that a game image corresponding to progress of the game played at the station 11 is projected to the display plate, and the display plate is regarded as the first screen 51 corresponding to the station 11. Another type of display plate to which decorative images are projected may be interposed between the first screens 51, and the display plates are regarded as the second screens 52. As has been described above, the screens are not limited to multiple first screens 51 made as a single piece, and may be multiple display plates connected continuously.

As shown in FIG. 4, each station 11 includes a pusher field F in which the coin pusher game is played. Each pusher field F is located between the players playing the game at the station 11 corresponding to the pusher field F and the display element 50. More specifically, each pusher field F is located before the first screen 51 corresponding to the station 11 corresponding to the pusher field F from the point of view of the players playing the game at the station 11.

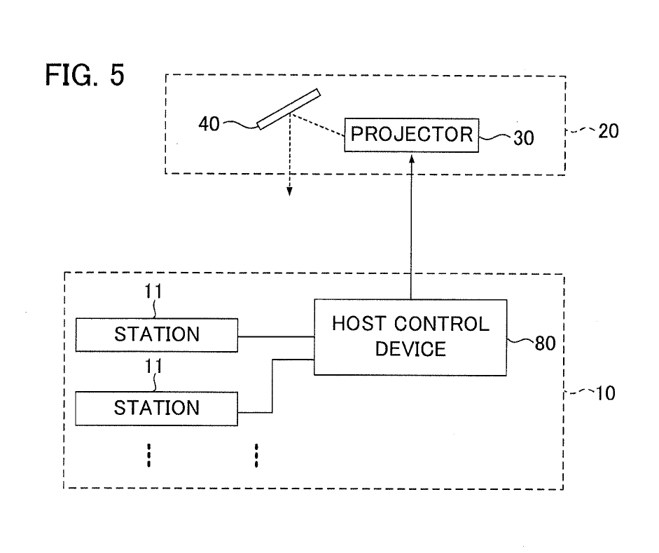

FIG. 5 is a block diagram showing schematically a controlling system in the game apparatus 100. As shown in FIG. 5, a host control device 80 (image generation device) is provided at the base unit 10. The host control device 80 is a computer for controlling the entire game apparatus including the multiple stations 11 and the ceiling unit 20.

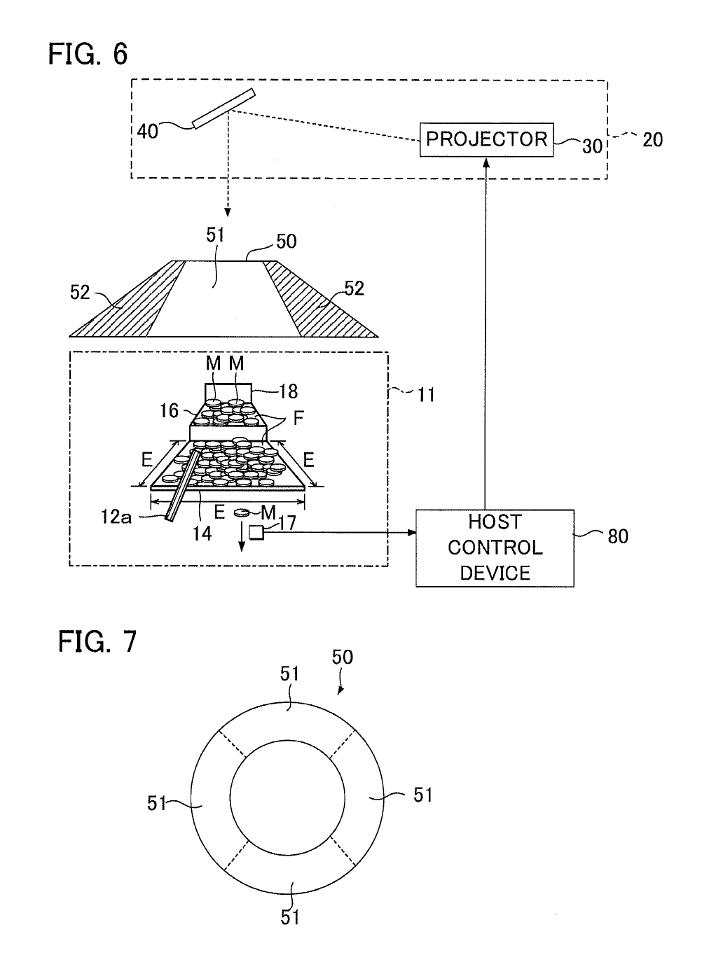

Next, with reference to FIG. 6, the flow of the coin pusher game played at stations 11 will be described briefly. FIG. 6 is a schematic view for explaining a coin pusher game played at a station 11. In the description below, the flow of the coin pusher game played at a single station 11 will be described, but the same applies to the game played at other stations 11.

As shown in FIG. 6, each station 11 includes a main table 14, a pusher table 16, and the above-mentioned medal slot 12a, and a medal detector 17. In FIG. 6, the other medal slot 12b in which the second player drops medals is not shown. The main table 14 is a plate member fixed generally horizontally. The pusher table 16 is a plate member located above the main table 14, and slides on the upper surface of the main table 14. More specifically, the pusher table 16 reciprocates back and fourth from the point of view of the players playing the game at the station 11. In this embodiment, the “pusher field F” is meant to be the upper surface of the main table 14 and the upper surface of the pusher table 16. As shown in FIG. 6, multiple medals M are located randomly on the pusher field F. The “medal” is a circular object necessary for participating in the game, and it may be called a coin. The medal or coin may include an actual hard currency coin and a token coin.

The medal slot 12a supplies the medal M dropped by the player to the main table 14. However, the medal M may be dropped from the medal slot 12a to the pusher table 16. By reciprocation of the pusher table 16, the medal dropped from the medal slot 12a to the main table 14 is pushed to move. By the movement of the medal M, existing medals M are pushed sequentially and fall from the edge E (periphery) of the main table 14. The medals M that have fallen are paid to the player. This is the first part of the game.

The medal detector 17 detects a medal M that has passed a checker (not shown) that is a predetermined route among medals that have fallen from the periphery E of the main table 14. The checker may not be limited to be a route for medals that have fallen from the main table 14, but may be a route for medals that will fall from the main table 14. Upon detecting a medal M by the medal detector 17, the host control device 80 executes a slot game that is the second part of the game. In the slot game, the host control device 80 executes an electronic lottery, and controls images on the first screen 51 corresponding to the station 11 for bringing additional excitement of the lottery and for indicating the result of the lottery (winning or losing). Details follow.

The host control device 80 generates projection image data indicating images to be projected to the display element 50 (more specifically, each first screen 51 and each second screen 52), and provides the projector 30 with the projection image data. More specifically, the host control device 80 generates the game image (the image for bringing additional excitement of the lottery, the image for indicating the result of the lottery, etc.) corresponding to progress of the game played at the station 11 as the image to be displayed at the first screen 51 corresponding to the station 11, and generates the decorative image that is not related to the game as the image to be displayed at the second screens 52. The host control device 80 writes the image data into a frame buffer (not shown). Consequently, the image data generated by different processes are combined and written into the frame buffer. The combination of image data generated by different processes is referred to as the “projection image data”. The projection image data written into the frame buffer is supplied to the projector 30.

On the basis of the projection image data supplied from the host control device 80, the projector 30 emits image light toward the reflector 40. The image light reflected by the reflector 40 is enlarged and is projected to the display element 50. To each of the first screens 51, the game image corresponding to the progress of the game played at the station 11 corresponding to the first screen 51 is projected. On the other hand, to each of the second screens 52, the decorative image is projected. For this purpose, the locations of the projector 30 and the reflector 40 are set.

As has been described above, in this embodiment, to the respective screens (the first screens 51 and the second screens 52), images to be displayed by the screens are projected by a single projector 30. For example, to each of the first screens 51, the game image corresponding to the progress of the game played at the station 11 corresponding to the first screen 51 is projected from a single projector 30. Accordingly, in this embodiment, it is not necessary to provide monitors (display devices) for showing game images corresponding to progress of the games played by the stations 11 to the stations 11, respectively, so that the production cost of the game apparatus is lower.

In this embodiment, since the first screens 51 are inclined with respect to the upper surface (horizontal plane) of the base unit 10, players playing the game at the stations 11 can easily watch the images projected to the first screens 51 corresponding to the stations 11. This is because a player can easily watch the game image on the first screen 51 when the line of sight of the player's eyes is near vertical to the first screen 51 to which the game image is projected. In this embodiment, since the inclination angles of the first screens 51 with respect to the horizontal plane are the same, the viewability of the game image on a first screen 51 is the same as that on another first screen 51.

Since the first screens 51 are inclined with respect to the horizontal plane, the viewability of the game images on the first screens 51 is maintained to be good even if the player is somewhat far from the first screen 51. Consequently, each pusher field F can be located before the first screen 51 corresponding to the station 11 corresponding to the pusher field F from the point of view of the players. This makes effective use of the space.

### B: Second Embodiment

The second embodiment is different from the first embodiment in that the projector 30 can project a set of images bridging a first screen 51 corresponding to a station 11 and another first screen 51 corresponding to a neighboring station 11. Details follow.

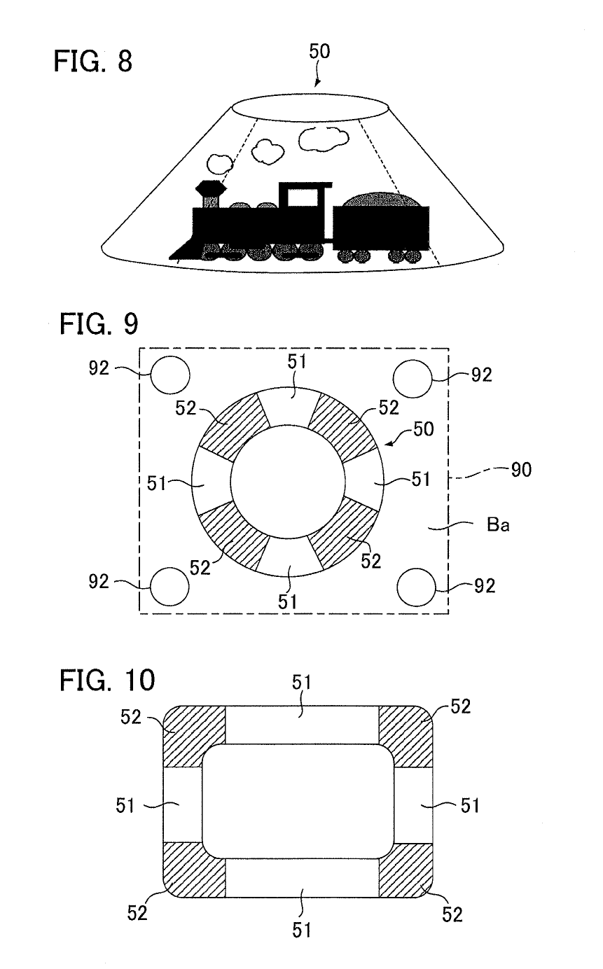

The host control device 80 executes a shooting game as the third part of the game if a predetermined condition is satisfied. When executing the shooting game, the host control device 80 generates projection image data indicating a laterally wide panoramic image bridging neighboring multiple first screens 51, and supplies the projection image data to the projector 30. In this embodiment, as shown in FIG. 7, multiple first screens 51 are connected seamlessly without the second screens 52, so as to cooperatively form the side face of the display element 50 of a shape of a circular truncated cone or a multi-sided truncated pyramid. An example of the panoramic image is, as shown in FIG. 8, a panoramic image of a steam locomotive running continuously around the side face of the display element 50 as the target of shooting. Of course, any kind of panoramic image may be produced. In this shooting game, when a player drops a medal M in the station 11, an image of a fired bullet is superimposed on the panoramic image in the first screen 51 corresponding to the station 11. If the bullet hits the steam locomotive (target) displayed on the first screen 51, medals M are paid to the player.

In this embodiment, since the multiple first screens 51 are formed as a single ring-shaped unit, a panoramic image showing a target continuously running can be represented naturally. In addition, according to this embodiment, a shooting game in which multiple players shoot bullets to the single target in a single panoramic image can be achieved.

### C: Variations

The above-described embodiments may be modified variously. Specific variations will be exemplified next. At least two examples optionally selected from among the examples below may be combined.

### C.1. Variation 1

For example, as shown in FIG. 9, a region 90 (which will be referred to as a “projected region 90”) among the upper surface of the game apparatus 100 of the game apparatus 100 to which an image is projected from the projector 30 may include subscreens 92 that are different from the display element 50. In this variation, the projector 30 may project an image to be displayed on each of the screens (first screens 51 and second screens 52) and images to be displayed on the subscreens 92 simultaneously. In the variation illustrated in FIG. 9, the projected region 90 includes four circular subscreens 92, but the number and the shape of the subscreens 92 can be optionally selected. For example, the projected region 90 may include only a single triangular subscreen 92.

In this variation, since an image different from that displayed on each screen can be displayed on each subscreen 92, additional excitement can be represented independently of the images on the screens.

The display element 50 and the subscreens 92 are located in part (referred to as “image regions”) of the projected region 90, and the projector 30 may cause an image projected to the other part (referred to as a background region Ba) of the projected region 90 other than the image regions to be black. Accordingly, the image regions and background region Ba can be clearly distinguished. As a result, images on the screens and the subscreens 92 can be emphasized.

In this variation, the host control device 80 generates projection image data indicating images to be displayed on the projected region by mixing image data indicating images to be displayed on the screens, image data indicating images to be displayed on the subscreens 92, and image data indicating images (black-only image) to be displayed on the background region Ba, and supplies the projection image data to the projector 30.

As mentioned above, in this specification, the term “screen” is defined as a surface to which an image is projected, but the “image” is meant to be images to be projected to the above-mentioned image regions, and to exclude the image of black-only to be projected to the background region Ba. In the first embodiment, the decorative image projected to be the second screens 52 may be black, but the “black” on the second screens 52 is an embodiment of the decorative image and is intentionally displayed, so that the “black” on the second screens 52 is included in the concept of “image”. However, the image of the black projected to the background region Ba is an embodiment for the purpose not to display anything on the background region Ba and the “black” is negatively displayed, so that the “black” on the background region Ba is excluded in the concept of “image”. In summary, the background region Ba is not the “screen” in this specification.

### C.2. Variation 2

In the above-described embodiments, as will be understood from FIG. 4, when the display element 50 is viewed from above, the first screens 51 are arranged annularly. However, the first screens 51 may be arranged in a ring shape. In other words, if multiple regions (first screens 51) corresponding to the stations 11 are formed on a single continuous annular face, the specific configuration is optional. For example, the configuration shown in FIG. 10 may be used. FIG. 10 is a plan view of the display element of the variation according to the present invention viewed from above. The term “ring shape” is not limited to be circular, and it may instead be an endless loop. The specific shape of the loop is not limited.

### C.3. Variation 3

In the first embodiment, the second screens 52 to which decorative images are projected in order to separate the first screens 51 are provided. However, it is possible to exclude the second screens 52. For example, decorative pictures may be illustrated on regions corresponding to the second screens 52 on the side face of the display element 50 of a shape of a circular truncated cone or a multi-sided truncated pyramid, instead of projecting images, for example, decorative images. In other words, the regions corresponding to the second screens 52 on the side face of the display element 50 of a shape of a circular truncated cone or a multi-sided truncated pyramid can be non-screen parts NS (to which no image is projected).

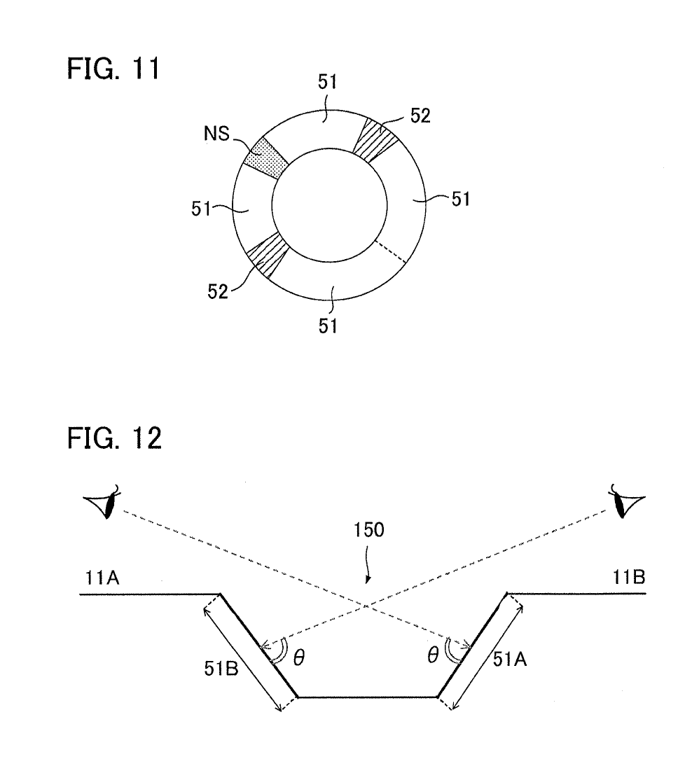

As shown in FIG. 11, the display element 50 may include a section in which the first screens 51 are connected seamlessly without the second screen 52 and the non-screen part NS (section in which the first screens 51 are arranged without a space) and another section in which the second screen 52 and the non-screen part NS are interposed between the first screens 51 (section in which the first screens 51 are arranged with spaces therebetween). In summary, some or all of first screens 51 may be arranged with spaces therebetween.

### C.4. Variation 4

In the above-described embodiments, the display element 50 protrudes from a central part of the upper surface of the base unit 100. However, it is possible to form a recess of a shape of a circular truncated cone or a multi-sided truncated pyramid at the central part of the upper surface of the base unit 100, and the recess may be used as a display element 150. In this variation, multiple first screens 51 to which game images are projected for the corresponding stations 11 are formed at the side face of the recess of the shape of a circular truncated cone or a multi-sided truncated pyramid.

In this variation, as shown in FIG. 12, the first screen 51A corresponding to a station 11A (viewed from the player at the station 11A) is inclined with respect to a horizontal plane, so that an angle θ formed by the first screen 51A and the line of sight of the player playing the game at the station 11A is near 90 degrees (vertical). Accordingly, the player can easily view the game image displayed on the first screen 51A. Similarly, the first screen 51B corresponding to a station 11B opposite to the station 11A beyond the base unit 10 is also inclined with respect to a horizontal plane, the player playing the game at the station 11B can easily view the game image displayed on the first screen 51B.

### C.5. Variation 5

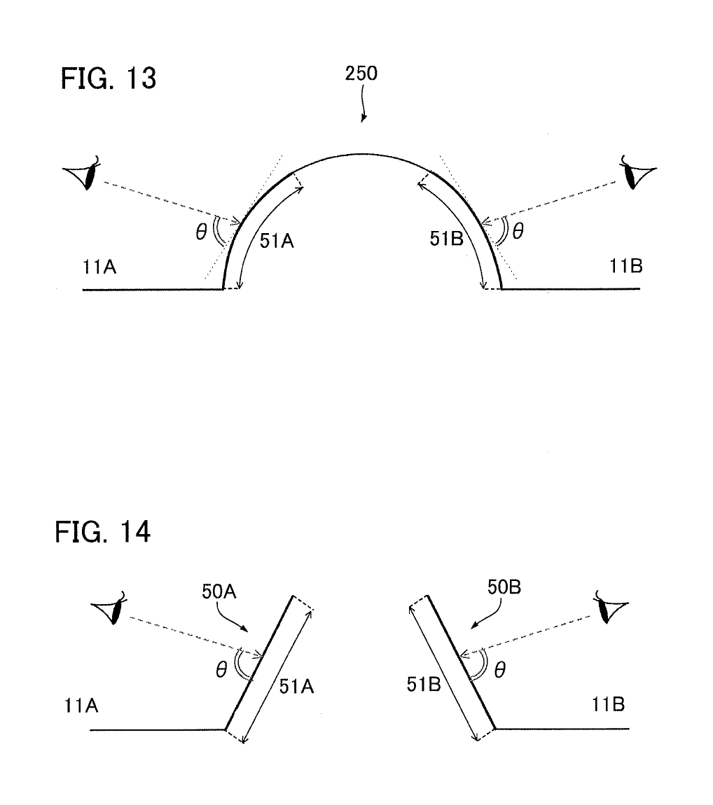

In the above-described embodiments, the shape of the display element 50 or 150 is a circular truncated cone or a multi-sided truncated pyramid. However, the shape of the display element may be selected optionally. For example, as shown in FIG. 13, a semispherical display element 250 may be used.

### C.6. Variation 6

In the above-described embodiments, a single display element 50, 150 or 250 is provided. However, different display elements may be provided for stations 11, respectively. For example, as shown in FIG. 14, a first screen 51A to which a game image corresponding to a station 11A may be formed at the surface of a display element 50A corresponding to the station 11A, whereas a first screen 51B to which a game image corresponding to a station 11B may be formed at the surface of a display element 50B corresponding to the station 11B. In this variation, since each of the first screens 51 is inclined with respect to a horizontal plane, an angle θ formed by the first screen 51 and the line of sight of the player playing the game at each station is near 90 degrees (vertical). Accordingly, each player can easily view the game image displayed on the corresponding first screen 51.

### C.7. Variation 7

In the first embodiment, a single first screen 51 corresponds to a single station 11 and the game image corresponding to progress of the game played at the station 11 is displayed on the single first screen. However, the number of the first screens 51 corresponding to a single station 11 may be freely selected. For example, four first screens 51 may be provided for each station 11 at which two players can play the game, so that two first screens 51 are provided for each player. In this case, the two first screens 51 corresponding to a player may display distinct game images or may cooperate to display a set of panoramic images bridging the two first screens 51.

In the above-described embodiments, two players can play the game at each station 11. However, the number of players who can play the game at each station is optional. For example, only one player may be permitted at each station 11.

### C.8. Variation 8

In the above-described embodiments, the game apparatus according to the present invention is exemplified as a game apparatus in which a coin pusher game and a shooting game are executed. However, the type of game executed in the game apparatus according to the present invention may be freely selected.

### REFERENCE SYMBOLS

10: Base Unit
11, 11a, 11b: Station
12a, 12b: Medal Slot
14: Main Table
16: Pusher Table
17: Medal Detector
20: Ceiling Unit
30: Projector (Image Projecting Device)
40: Reflector
50, 150, 250: Display Element
51: First Screen
52: Second Screen
61: Trestle
62: Attachment Plate
80: Host Control Device (Image Generation Device)
90: Projected Region
92: Subscreen
100: Game Apparatus
M: Medal

1. A game apparatus comprising:
multiple stations at each of which at least one player plays a game; multiple screens, each of the multiple screens being associated with one of the multiple stations, each of the multiple stations being associated with at least one of the multiple screens; and
a single image projecting device adapted for projecting an image to be displayed on each of the screens.

2. The game apparatus according to claim 1, wherein each of the screens is inclined with respect to a horizontal plane.

3. The game apparatus according to claim 2, wherein the screens are formed as a single ring-shaped unit.

4. The game apparatus according to claim 2, wherein part or all of screens are arranged with spaces therebetween.

5. The game apparatus according to claim 2, wherein each of the stations includes a field in which a game is played.

6. The game apparatus according to claim 1, wherein the image projecting device is adapted for projecting a set of images bridging neighboring screens.

7. The game apparatus according to claim 1, further comprising at least one subscreen, wherein the image projecting device is adapted for projecting an image to be displayed on each of the screens and an image to be displayed on the subscreen simultaneously.

8. The game apparatus according to claim 7, wherein the screens and the at least one subscreen are located in a projected region projected by the image projecting device, and wherein the image projecting device causes an image projected to the projected region other than the screens and the at least one subscreen to be black.

9. The game apparatus according to claim 8, further comprising an image generation device adapted for generating projection image data indicating images to be displayed on the projected region by mixing image data indicating images to be displayed on the screens and image data indicating images to be displayed on the at least one subscreen, and is adapted to supply the projection image data to the image projecting device.

10. The game apparatus according to claim 6, further comprising a reflector located above or below the screens and the at least one subscreen, the reflector reflecting image light irradiated from the image projecting device to project the images to the screens and the at least one subscreen.
